(19) United States
(12) Patent Application Publication
(10) Pub. No.: US 2026/0111050 A1
(43) Pub. Date: Apr. 23, 2026

(54) FAST RESPONSE LINEAR REGULATOR WITHOUT CONTINUOUS-TIME HIGH-PRECISION ERROR AMPPLIFIER

(71) Applicant: PixArt Imaging Incorporation, Hsinchu (TW)

(72) Inventor: Kok-Siang Tan, Penang (MY)

(21) Appl. No.: 18/920,185

(22) Filed: Oct. 18, 2024

(51) Int. Cl. G05F 1/575; G05F 1/571

(52) U.S. Cl. CPC G05F 1/575; G05F 1/571

(57) ABSTRACT

A linear regulator includes: a first output stage circuit for generating a first output voltage according to a first control voltage; and a calibration circuit, enabled during a first calibration period after startup of the linear regulator. During the first calibration period, the calibration circuit is configured to operably generate the first control voltage based on an output-related signal and a reference voltage, and the output-related signal is related to the first output voltage. The first output stage circuit and the calibration circuit form a first control loop which enters an open-loop state after the end of the first calibration period. The first output stage circuit includes a second control loop, configured to operably regulate the first output voltage in a closed-loop manner based on the first control voltage and a variation of the first output voltage during an operational period following the first calibration period.

### BACKGROUND OF THE INVENTION

### Field of Invention

The present invention relates to a linear regulator. Particularly it relates to a fast response linear regulator without continuous-time high-precision error amplifier.

### Description of Related Art

FIG. 1 shows a schematic diagram of a prior art linear regulator 1001. The linear regulator 1001 includes an error amplifier 900 and an output stage circuit 910. This prior art linear regulator 1001 includes a feedback tracking loop and a fast-tracking loop. The feedback tracking loop regulates an output voltage level of an output voltage Vregout based on a feedback voltage Vfb and a reference voltage Vref. The fast-tracking loop responds to fast load transients on the output voltage Vregout. In this prior art, both the feedback tracking loop and the fast-tracking loop regulate the output voltage Vregout in a closed-loop manner.

As shown in FIG. 1, a power transistor Mpp of the output stage circuit 910 generates the output voltage Vregout according to a driving voltage Vpg. A current steering transistor Mset is controlled by a control voltage Vset generated by the error amplifier 900 to steer a first bias current Ibb1 and a second bias current Ibb2 of a primary bias current Ibb.

From one perspective, in the prior art, the feedback tracking loop (i.e., the error amplifier 900) is configured to operate in response to the error in the output voltage Vregout at DC and lower frequencies, providing high-accuracy regulation. Meanwhile, the fast-tracking loop (i.e., the output stage circuit 910) is configured to operate in response to transients in the output voltage Vregout at higher frequencies. It should be noted that both the feedback tracking loop and the fast-tracking loop operate continuously in a closed-loop manner.

The drawback of the prior art shown in FIG. 1 is that the error amplifier 900 of the linear regulator 1001 must operate continuously in a closed-loop manner. Though this configuration allows for fast response with high accuracy, the design of the amplifier and the resistors R1 and R2 results in higher cost and increased power consumption.

In view of this, the present invention addresses the deficiencies of the aforementioned prior art by proposing an innovative linear regulator that eliminates the need for an error amplifier or, more broadly, the regulation of the output voltage through a high-precision feedback loop which must operate continuously. This approach achieves lower cost and reduced power consumption.

### SUMMARY OF THE INVENTION

From one perspective, the present invention provides a linear regulator, comprising: a first output stage circuit, configured to operably generate a first output voltage according to a first control voltage; and a calibration circuit, enabled during a first calibration period after the startup of the linear regulator, wherein during the first calibration period, the calibration circuit is configured to operably generate the first control voltage based on an output-related signal and a reference voltage, and the output-related signal is related to the first output voltage; wherein the first output stage circuit and the calibration circuit form a first control loop, wherein the first control loop enters an open-loop state after the end of the first calibration period; wherein the first output stage circuit includes a second control loop, configured to operably regulate the first output voltage in a closed-loop manner based on the first control voltage and a variation of the first output voltage during an operational period following the first calibration period.

In one embodiment, the calibration circuit is further configured to operably store the first control voltage after the end of the first calibration period; wherein after the calibration circuit stores the first control voltage, a portion of the calibration circuit is disabled, thereby entering the open-loop state.

In one embodiment, the linear regulator further comprises: a sensing circuit, configured to operably generate the output-related signal based on the first output voltage during the first calibration period; wherein the calibration circuit includes: a comparator, configured to generate a comparison signal based on a comparison between the output-related signal and the reference voltage during the first calibration period; and a control circuit, configured to operably generate the first control voltage based on the comparison signal during the first calibration period; wherein the sensing circuit is disabled and/or the comparator is disabled after the calibration circuit stores the first control voltage.

In one embodiment, the control circuit includes: an adjustment circuit, configured to operably generate an adjustment signal based on the comparison signal during the first calibration period, and configured to operably store the adjustment signal after the end of the first calibration period; and a voltage generation circuit, configured to generate the first control voltage based on the adjustment signal.

In one embodiment, the calibration circuit calibrates and generates the first control voltage according to a linear search method or a binary search method, such that a difference between a level of the output-related signal and a level of the reference voltage is less than a first threshold, thereby rendering a difference between a level of the first output voltage and a level of a target voltage less than a second threshold.

In one embodiment, the first output stage circuit includes: a control terminal, configured to receive the first control voltage; a regulated output terminal, configured to generate the first output voltage; a bias current source, configured to operably generate a primary bias current at a bias node, wherein the primary bias current includes a first bias current and a second bias current; and a first current branch and a second current branch, wherein the first current branch and the second current branch are coupled to the bias node, wherein the first bias current and the second bias current flow through the first current branch and the second current branch respectively; wherein the first current branch is configured to operably generate a driving voltage according to the first bias current; wherein the second current branch is configured to operably steer the second bias current, so as to steer the first bias current according to a voltage difference between the first output voltage and the first control voltage, and is configured to regulate the first output voltage according to the driving voltage and the second bias current.

In one embodiment, the first current branch includes: a bias load transistor and a common gate transistor, which are coupled in series between an input power and the bias node, and are configured to operably generate the driving voltage at a driving node according to the first bias current, wherein gates of the bias load transistor and the common gate transistor are biased by a first bias voltage and a second bias voltage, respectively; wherein the second current branch includes: a power transistor and a current steering transistor, which are coupled in series between the input power and the bias node, and are coupled at the regulated output terminal, wherein the driving voltage and the first control voltage are configured to control gates of the power transistor and the current steering transistor to generate the first output voltage.

In one embodiment, the first output stage circuit includes an overshoot suppressor circuit, wherein the overshoot a first overshoot suppressing suppressor circuit includes: transistor and a suppressing resistor, which are coupled in series to the regulated output terminal and configured as a source follower, wherein a gate and a drain of the first overshoot suppressing transistor are coupled to the bias node and the regulated output terminal, respectively; and a second overshoot suppressing transistor, coupled between the regulated output terminal and a ground, wherein a gate of the second overshoot suppressing transistor is coupled to an output of the source follower; wherein the first overshoot suppressing transistor and the second overshoot suppressing transistor are configured to turn on when an overshoot of the first output voltage occurs, thereby suppressing the overshoot.

In one embodiment, the linear regulator further comprises: a plurality of output stage circuits, including at least the first output stage circuit and a second output stage circuit; wherein the second output stage circuit is configured to operably generate a second output voltage according to a second control voltage; wherein the calibration circuit is further configured to be enabled during a second calibration period following the first calibration period, wherein during the second calibration period, the calibration circuit is configured to operably generate the second control voltage based on the output-related signal and the reference voltage, and the output-related signal is related to the second output voltage; wherein the second output stage circuit and the calibration circuit form a third control loop, wherein the third control loop enters the open-loop state after the end of the second calibration period; wherein the second output stage circuit includes a fourth control loop, configured to operably regulate the second output voltage in the closed-loop manner based on the second control voltage and a variation of the second output voltage during the operational period following the second calibration period.

In one embodiment, the calibration circuit is further configured to operably store the second control voltage after the end of the second calibration period; wherein after the calibration circuit stores the second control voltage, a portion of the calibration circuit is disabled, thereby entering the open-loop state.

In one embodiment, the sensing circuit is further configured to operably generate the output-related signal based on the second output voltage during the second calibration period; wherein the control circuit is further configured to operably generate the second control voltage based on the comparison signal; wherein the sensing circuit is disabled and/or the comparator is disabled after the calibration circuit stores the second control voltage.

In one embodiment, each of the first output stage circuit and the second output stage circuit includes: a control terminal and a regulated output terminal; a bias current source, configured to operably generate a primary bias current at a bias node, wherein the primary bias current includes a first bias current and a second bias current; and a first current branch and a second current branch, wherein the first current branch and the second current branch are coupled to the bias node, wherein the first bias current and the second bias current flow through the first current branch and the second current branch respectively; wherein the first current branch is configured to operably generate a driving voltage according to the first bias current; wherein the second current branch is configured to operably steer the second bias current, so as to steer the first bias current according to a voltage difference between a regulated output voltage at the regulated output terminal and a control voltage received through the control terminal, and is configured to regulate the regulated output voltage according to the driving voltage and the second bias current; wherein the control voltage of the first output stage circuit and the control voltage of the second output stage circuit correspond to the first control voltage and the second control voltage respectively, and the regulated output voltage of the first output stage circuit and the regulated output voltage of the second output stage circuit correspond to the first output voltage and the second output voltage respectively.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art linear regulator.

FIG. 2 shows a block diagram of an embodiment of the linear regulator according to the present invention.

FIG. 3 shows a schematic diagram of an embodiment of the linear regulator according to the present invention.

FIG. 4A shows a schematic diagram of a specific embodiment of the output stage circuit of the linear regulator according to the present invention.

FIG. 4B shows a schematic diagram of a specific embodiment of the output stage circuit of the linear regulator according to the present invention.

FIG. 5 shows a schematic diagram of a specific embodiment of the output stage circuit having an overshoot suppressor circuit of the linear regulator according to the present invention.

FIG. 6 shows a block diagram of an embodiment of the linear regulator according to the present invention.

FIG. 7 shows a block diagram of an embodiment of the control circuit of the linear regulator according to the present invention.

FIG. 8 shows a block diagram of an embodiment of the control circuit of the linear regulator according to the present invention.

FIG. 9 shows a schematic diagram of a specific embodiment of the control circuit of the linear regulator according to the present invention.

FIG. 10 shows a schematic diagram of a specific embodiment of the control circuit of the linear regulator according to the present invention.

FIG. 11 shows a schematic diagram of a specific embodiment of the voltage generation circuit of the linear regulator according to the present invention.

FIG. 12 shows a schematic diagram of a specific embodiment of the voltage generation circuit of the linear regulator according to the present invention.

FIG. 13 shows a schematic diagram of a specific embodiment of the voltage generation circuit of the linear regulator according to the present invention.

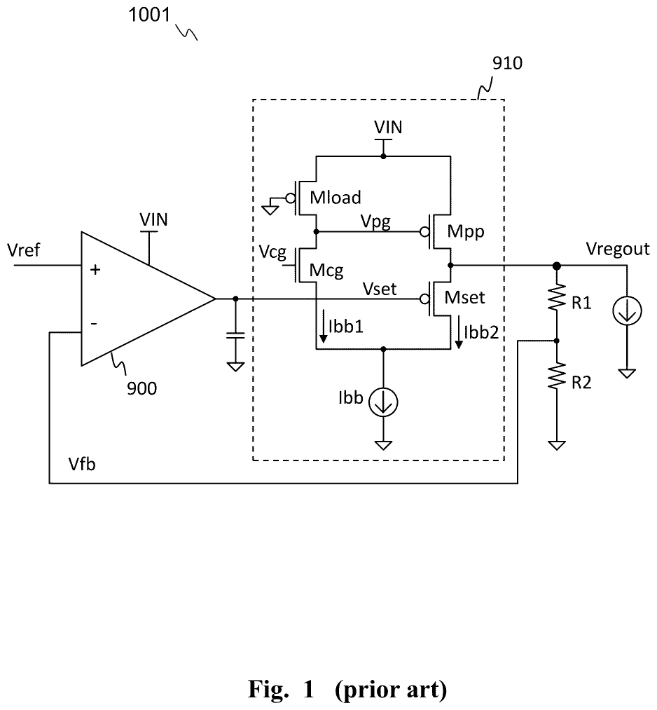

### DESCRIPTION OF THE PREFERRED EMBODIMENTS

The drawings as referred to throughout the description of the present invention are for illustration only, to show the interrelations between the circuits and the signal waveforms, but not drawn according to actual scale.

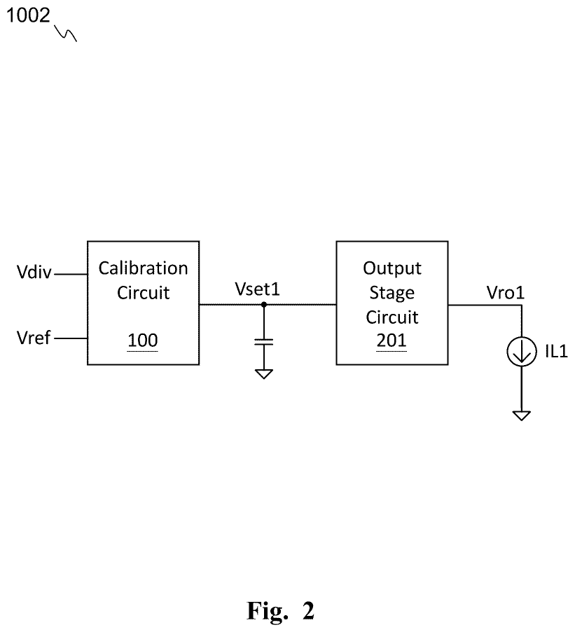

FIG. 2 shows a block diagram of an embodiment of the linear regulator according to the present invention (linear regulator 1002). In one embodiment, as shown in FIG. 2, the linear regulator 1002 comprises an output stage circuit 201 and a calibration circuit 100. The output stage circuit 201 is configured to operably generate a first output voltage Vro1 according to a first control voltage Vset1. The calibration circuit 100 is enabled during a first calibration period after the startup of the linear regulator 1002.

In one embodiment, during the first calibration period, the calibration circuit 100 is configured to operably generate the first control voltage Vset1 based on an output-related signal Vdiv and a reference voltage Vref. In this embodiment, the output-related signal Vdiv is related to the first output voltage Vro1 during the first calibration period. In one embodiment, the output stage circuit 201 and the calibration circuit 100 form a first control loop.

In one embodiment, the calibration circuit 100 is further configured to operably store the first control voltage Vset1 after the end of the first calibration period. After the calibration circuit 100 stores the first control voltage Vset1, a portion of the calibration circuit 100 is disabled, thereby rendering the first control loop to enter an open-loop state.

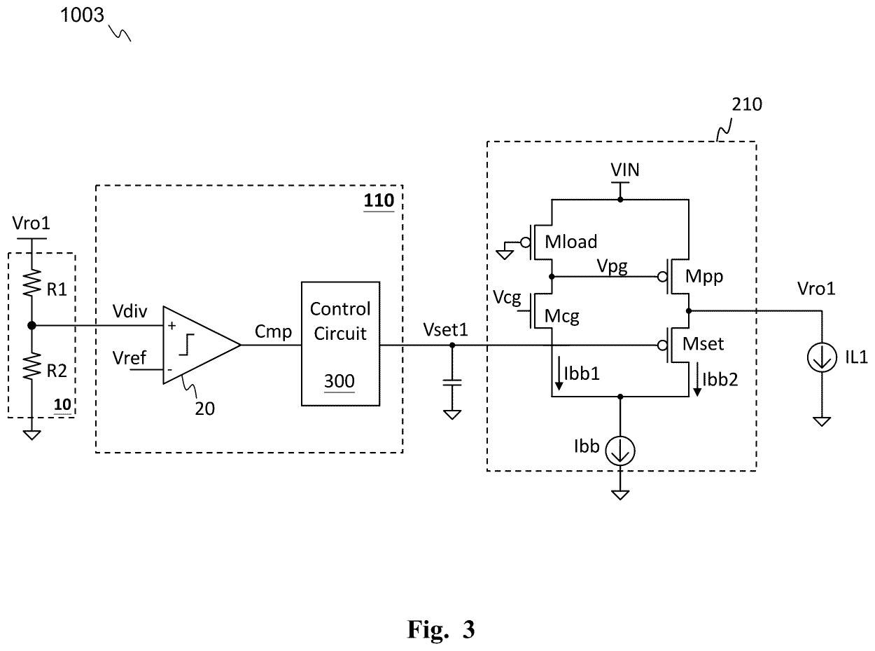

FIG. 3 shows a schematic diagram of an embodiment of the linear regulator according to the present invention (linear regulator 1003). In one embodiment, the linear regulator 1003 further comprises a sensing circuit 10. The sensing circuit 10 is configured to operably generate the output-related signal Vdiv based on the first output voltage Vro1 during the first calibration period. In this embodiment, the sensing circuit 10 includes resistors R1 and R2 for dividing the first output voltage Vro1 to generate the output-related signal Vdiv. In another embodiment, the sensing circuit 10 can be omitted, in other words, the output-related signal Vdiv can be directly connected from the first output voltage Vro1, having a feedback gain being unity.

In one embodiment, the calibration circuit 110 includes: a comparator 20 and a control circuit 300. In one embodiment, the comparator 20 is configured to generate a comparison signal Cmp based on a comparison between the output-related signal Vdiv and the reference voltage Vref during the first calibration period. The control circuit 300 is configured to operably generate the first control voltage Vset1 based on the comparison signal Cmp during the first calibration period. In one embodiment, the sensing circuit 10 is disabled and/or the comparator 20 is disabled after the calibration circuit 110 stores the first control voltage Vset1.

In one embodiment, as shown in FIG. 3, the output stage circuit 210 includes a second control loop which is configured to operably regulate the first output voltage Vro1 in a closed-loop manner based on the first control voltage Vset1, specially in response to transients of the first output voltage Vro1, during an operational period following the first calibration period. In other words, the second control loop can be considered as a fast-tracking loop. The details of the second control loop will be described in the following embodiments.

In one specific embodiment, during the first calibration period, the calibration circuit 110 iteratively calibrates and generates the first control voltage Vset1 according to a linear search method or a binary search method, until a difference between a level of the output-related signal Vdiv and a level of the reference voltage Vref is less than a first threshold (i.e. the output-related signal Vdiv is sufficiently close to the reference voltage Vref). This ensures that a difference between a level of the first output voltage Vset1 and a level of a target voltage less than a second threshold (i.e. the first output voltage Vset1 is sufficiently close to the target voltage, meeting a predetermined requirement). Subsequently, the calibration circuit 110 stores the first control voltage Vset1 after the end of the first calibration period.

Note that, since the linear regulator of the present invention does not need a high-precision error amplifier (as that aforementioned in the prior art) required to continuously operate for high-accuracy regulation, the cost and power consumption can be reduced. More specifically, according to the present invention, a portion of the calibration circuit is disabled to enter the open-loop state during the operational period, thus low cost and low power consumption can be achieved.

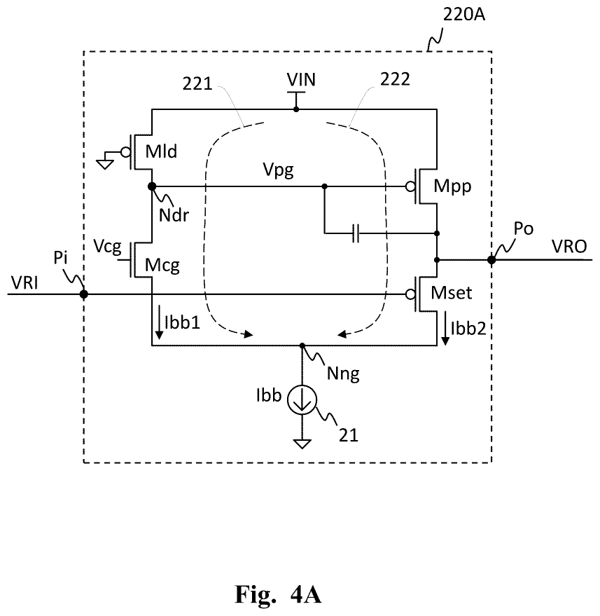

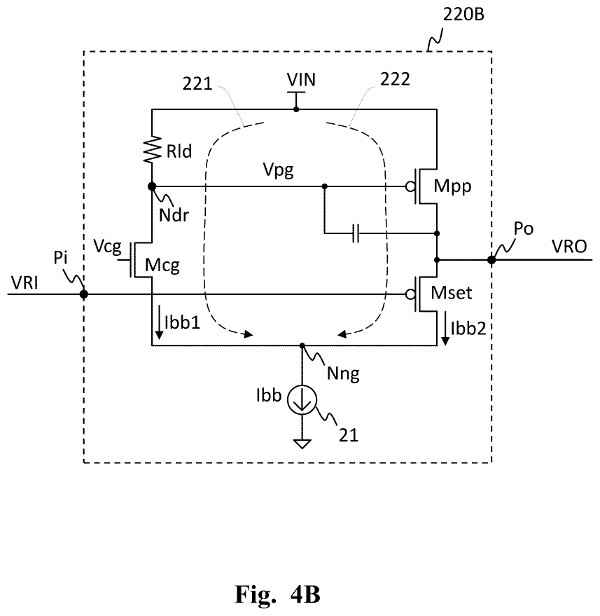

FIG. 4A shows a schematic diagram of a specific embodiment of the output stage circuit of the linear regulator according to the present invention. In one embodiment, the topology of the output stage circuit 210 in FIG. 3 is identical and corresponds to the output stage circuit 220A shown in FIG. 4A. In one embodiment, the output stage circuit 220A includes a power transistor Mpp, a current steering transistor Mset, a common gate transistor Mcg, a bias load transistor Mld and a bias current source 21.

In one embodiment, the bias current source 21 is configured to operably generate a primary bias current Ibb at a bias node Nng. The bias load transistor Mld and the common gate transistor Mcg are coupled in series between an input voltage VIN and the bias node Nng to form a first current branch 221. The power transistor Mpp and the current steering transistor Mset are coupled in series between the input voltage VIN and the bias node Nng to form a second current branch 222, wherein the power transistor Mpp and the current steering transistor Mset are coupled at a regulated output terminal Po.

In one embodiment, the gate of the bias load transistor Mld is coupled to a fixed voltage, for example a ground level as shown in FIG. 4A. The gate of the common gate transistor Mcg is biased by a bias voltage Vcg. In one embodiment, the bias load transistor Mld and the common gate transistor Mcg are configured to operably generate a driving voltage Vpg, at the driving node Ndr where the bias load transistor Mld and the common gate transistor Mcg are coupled, according to a first bias current Ibb1 of the primary bias current Ibb. Note that the first bias current Ibb1 of the primary bias current Ibb flows through the first current branch 221.

In this embodiment, the power transistor Mpp is configured as an inverting amplifier stage (i.e. drain coupled to the regulated output terminal Po) and is controlled by the driving voltage Vpg, and the current steering transistor Mset is configured as a source follower stage (i.e. source coupled to the regulated output terminal Po) and is controlled by a control voltage VRI through a control terminal Pi of the output stage circuit 220A. The power transistor Mpp and the current steering transistor Mset are configured to generate an output voltage VRO at the regulated output terminal Po of the output stage circuit 220A. A second bias current Ibb2 of the primary bias current Ibb flows through the aforementioned second current branch 222.

The gate-source voltage of current steering transistor Mset (i.e. the voltage difference between the control voltage VRI and the output voltage VRO) controls the level of the second bias current Ibb2. The first bias current Ibb1 also changes in response to the change of the second bias current Ibb2, since the sum of the second bias current Ibb2 and the first bias current Ibb1 is equal to the primary bias current Ibb that has a fixed value. For example, when the voltage difference between the control voltage VRI and the output voltage VRO is reduced (e.g. due to the output voltage VRO drops), the second bias current Ibb2 decreases accordingly, and the first bias current Ibb1 increases in response to the decreasing of the second bias current Ibb2. In this case, the driving voltage Vpg decreases in response to the increasing of the first bias current Ibb1, which turns on the power transistor Mpp more and pulls the output voltage VRO up. In other words, the output stage circuit 220A is apt to regulate the output voltage VRO, in a negative feedback manner, at a level which is the control voltage VRI level-shifted by the source-gate voltage of current steering transistor Mset. From one perspective, the output stage circuit can be considered as a closed-loop.

FIG. 4B shows a schematic diagram of a specific embodiment of the output stage circuit 220B of the linear regulator according to the present invention. The output stage circuit 220B is similar to the output stage circuit 220A in FIG. 4A. In this embodiment, the bias load device of the output stage circuit 220B is a bias load resistor Rld, and all the aforementioned functions keep the same in this embodiment.

Note that, the control voltage VRI and the output voltage VRO in FIGS. 4A and 4B can respectively correspond to the first control voltage Vset1 and the first output voltage Vro1 in FIG. 3.

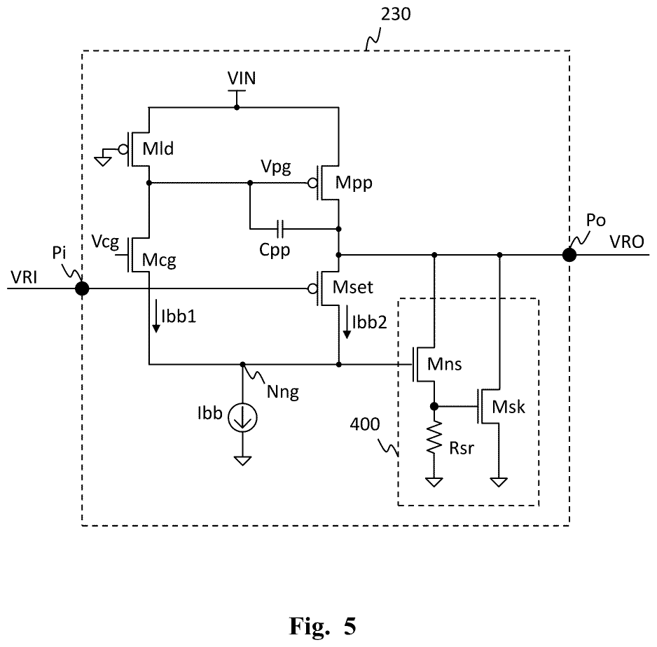

FIG. 5 shows a schematic diagram of a specific embodiment of the output stage circuit 230 having an overshoot suppressor circuit 400 of the linear regulator according to the present invention. In one embodiment, the output stage circuit 230 further includes an overshoot suppressor circuit 400 for mitigating overshoot at the output of the regulator. In this embodiment, the overshoot suppressor circuit 400 includes a first overshoot suppressing transistor Mns, an overshoot suppressing resistor Rsr and a second overshoot suppressing transistor Msk. The first overshoot suppressing transistor Mns and the overshoot suppressing resistor Rsr are coupled in series between the regulated output terminal Po and ground and is configured as a source follower. More specifically, a gate and a drain of the first overshoot suppressing transistor Mns are coupled to the bias node Nng and the regulated output terminal Po. The second overshoot suppressing transistor Msk is coupled between the regulated output terminal Po and ground. More specifically, a gate of the second overshoot suppressing transistor Msk is coupled to an output of the source follower. When an overshoot occurs at the output voltage VRO, the current steering transistor Mset steers the second bias current Ibb2 larger, and the voltage on the bias node Nng increases accordingly. Consequently, the first overshoot suppressing transistor Mns and the second overshoot suppressor transistor Msk are turned on, thereby pulling the output voltage VRO down and suppressing the overshoot of the output voltage VRO.

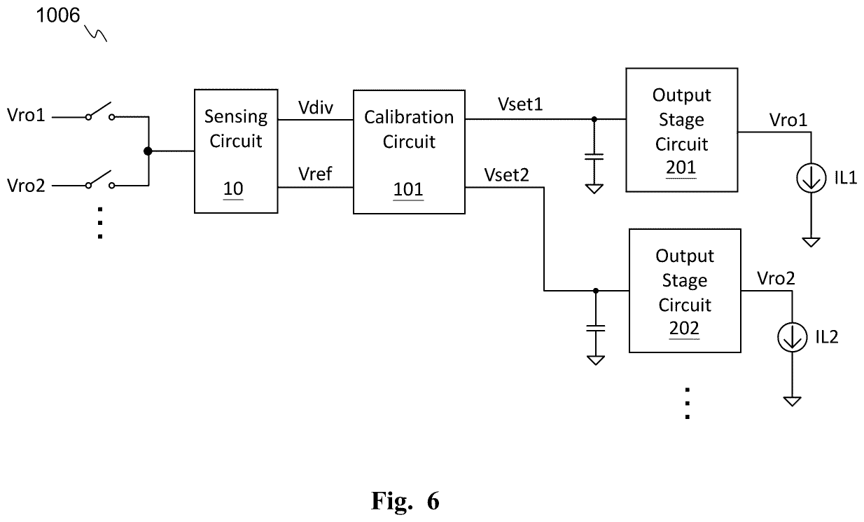

FIG. 6 shows a block diagram of an embodiment of the linear regulator according to the present invention. In one embodiment, the linear regulator of the present invention can support multiple outputs. In one embodiment, as shown in FIG. 6, the linear regulator 1006 further comprises a plurality of output stage circuits, including at least two output stage circuits. In one specific embodiment, the plurality of output stage circuits includes the output stage circuit 201 and an output stage circuit 202. In one embodiment, all the aforementioned functions of the output stage circuit 201 keep the same in this embodiment. In one embodiment, the output stage circuit 202 is configured to operably generate a second output voltage Vro2 according to a second control voltage Vset2. Note that, the second output voltage Vro2 can be equal to or different from the first output voltage Vro1.

In one embodiment, the calibration circuit 101 is further configured to be enabled during a second calibration period, for example following the first calibration period. During the second calibration period, the calibration circuit 101 is configured to operably generate the second control voltage Vset2 based on the output-related signal Vdiv and the reference voltage Vref. In this embodiment, the output-related signal Vdiv is switched to be related to the second output voltage Vro2 during the second calibration period. In one embodiment, the output stage circuit 202 and the calibration circuit 101 form a third control loop. The third control loop enters the open-loop state after the end of the second calibration period.

In one embodiment, the output stage circuit 202 includes a fourth control loop, configured to operably regulate the second output voltage Vro2 in the closed-loop manner based on the second control voltage Vset2 and a variation (including transients) of the second output voltage Vro2 during the operational period following the second calibration period. In one embodiment, the topologies of the output stage circuits 201 and 202 in FIG. 6 are identical and correspond to the output stage circuit 220A shown in FIG. 4A.

Note that, in this embodiment, the sensing circuit 10 is configured to operably generate the output-related signal Vdiv based on the output voltage Vro1 during the first calibration period and the output voltage Vro2 during the second calibration period, respectively. In other words, the output-related signal Vdiv is related to the output voltage Vro1 during the first calibration period and to the output voltage Vro2 during the second calibration period. In this embodiment, the calibration circuit 101 is configured to operably sequentially generate the first control voltage Vset1 during the first calibration period and the second control voltage Vset2 during the second calibration period, and after the end of the second calibration period, the second control voltage Vset2 is stored. Subsequently, during the operational period, at least a portion of the calibration circuit 101 is disabled.

Still note that, the output stage circuits 201 and 202 are configured to operably generate the first output voltage Vro1 and the second output voltage Vro2 respectively according to the first control voltage Vset1 and the second control voltage Vset2. In this embodiment, the output voltages Vro1 and Vro2 are configured to drive loads IL1 and IL2 respectively. Other details of the linear regulator 1006 can be deduced from the aforementioned embodiments.

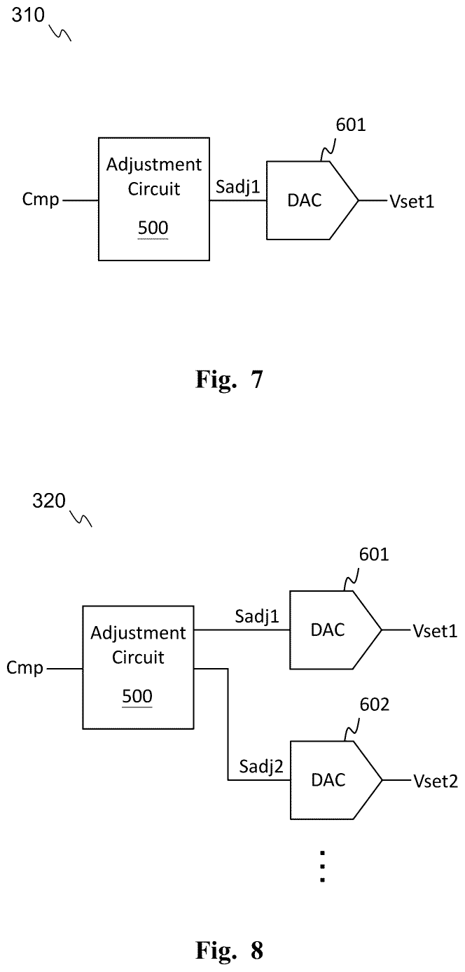

FIG. 7 shows a block diagram of an embodiment of the control circuit of the linear regulator according to the present invention. In one embodiment, the control circuit 300 in FIG. 3 can be configured as the control circuit 310 in FIG. 7. In one embodiment, the control circuit 310 includes an adjustment circuit 500 and a voltage generation circuit. In this embodiment, the voltage generation circuit is configured as a DAC 601. The adjustment circuit 500 is configured to operably generate an adjustment signal Sadj1 based on the comparison signal Cmp during the first calibration period. The adjustment circuit 500 is further configured to operably store the adjustment signal Sadj1 after the end of the first calibration period, thereby storing the first control voltage Vset1. The DAC 601 is configured to generate the first control voltage Vset1 based on the adjustment signal Sadj1.

FIG. 8 shows a block diagram of an embodiment of the control circuit of the linear regulator according to the present invention. The control circuit 320 of FIG. 8 is an embodiment of the control circuit in the calibration circuit 101 of FIG. 6. The control circuit 320 is similar to the control circuit 310 in FIG. 7. In this embodiment, the voltage generation circuit further includes at least another DAC 602. The DAC 602 is configured to generate the second control voltage Vset2 based on the adjustment signal Sadj2 during the second calibration period. Other functions of the DAC 602 keep identical with DAC 601 in this embodiment.

Note that, in the embodiments of FIG. 7 and FIG. 8, the adjustment signal Sadj1 and/or the adjustment signal Sadj2 is generated according to the comparison signal Cmp, thereby calibrating the corresponding first control voltage Vset1 and/or second control voltage Vset2.

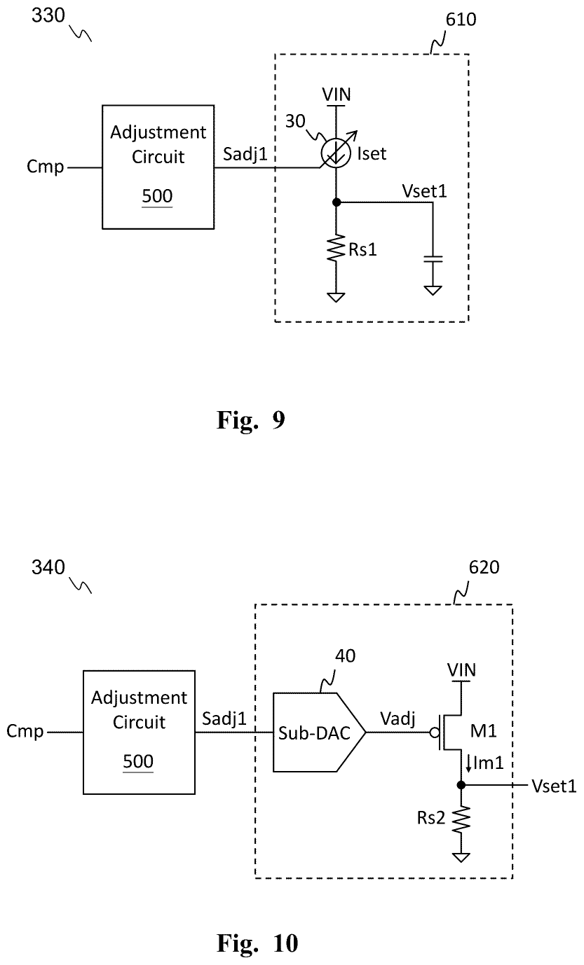

FIG. 9 shows a schematic diagram of a specific embodiment of the control circuit (330) of the linear regulator according to the present invention. The DAC 610 in FIG. 9 is a specific embodiment of the DAC 601 in FIG. 7 or one of the DACs in FIG. 8. In one embodiment, the DAC 610 includes a programmable current source 30 and a resistor Rs1. In this embodiment, the programmable current source 30 is configured to generate a current Iset based on the adjustment signal Sadj1. The current Iset and the resistor Rs1 are configured to generate the first control voltage Vset1.

FIG. 10 shows a schematic diagram of a specific embodiment of the control circuit (340) of the linear regulator according to the present invention. The DAC 620 in FIG. 10 is a specific embodiment of the DAC 601 in FIG. 7 or one of the DACs in FIG. 8. In one embodiment, the DAC 620 includes a sub-DAC 40, a PMOS M1 and a resistor Rs2. In this embodiment, the sub-DAC 40 is configured to generate an adjustment voltage Vadj based on the adjustment signal Sadj1. The PMOS M1 is configured to generate the current Im1 according to the adjustment voltage Vadj. The current Im1 and the resistor Rs2 are configured to generate the first control voltage Vset1.

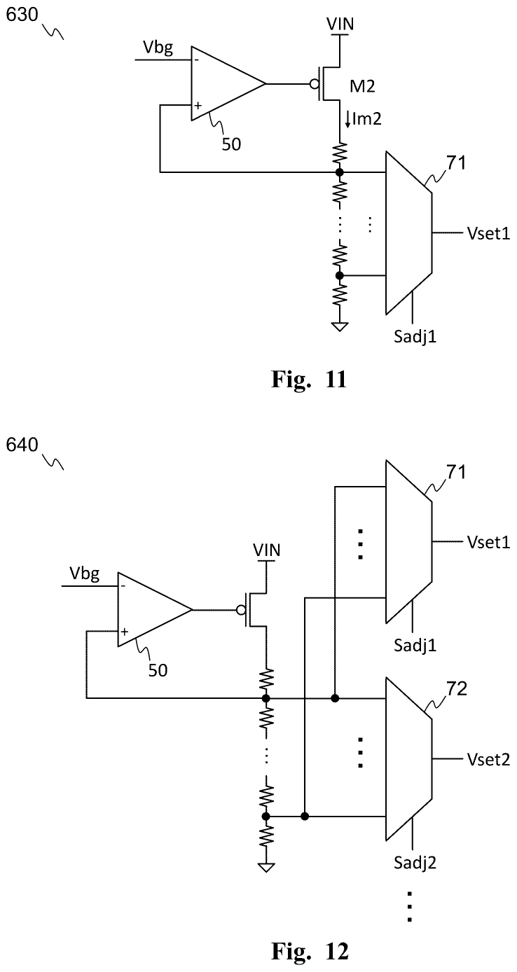

FIG. 11 shows a schematic diagram of a specific embodiment of the voltage generation circuit of the linear regulator according to the present invention. In one embodiment, the voltage generation circuit is configured as the DAC 630. The DAC 630 in FIG. 11 is a specific embodiment of the DAC 601 in FIG. 7. In one embodiment, the DAC 630 includes an amplifier 50, a PMOS M2, a select circuit 71 and a resistor string as a voltage divider. In this embodiment, an output of the amplifier 50 is configured to control the PMOS M2 to generate a current Im2 according to, for example a bandgap voltage Vbg. The current Im2 and the plurality of resistors (i.e., resistor string) are configured to generate a plurality of divided voltages. The select circuit 71 selects one of the divided voltages to generate the first control voltage Vset1 according to the adjustment signal Sadj1.

FIG. 12 shows a schematic diagram of a specific embodiment of the voltage generation circuit of the linear regulator according to the present invention. In one embodiment, the voltage generation circuit is configured as the DAC 640. The DAC 640 of FIG. 12 is an embodiment of the DACs of FIG. 8. The DAC 640 is similar to the DAC 630 in FIG. 11. In this embodiment, the DAC 640 further includes at least another select circuit 72. The select circuit 72 selects one of the divided voltages to generate the second control voltage Vset2 according to the adjustment signal Sadj2. Other functions of the select circuit 72 keep the same in this embodiment.

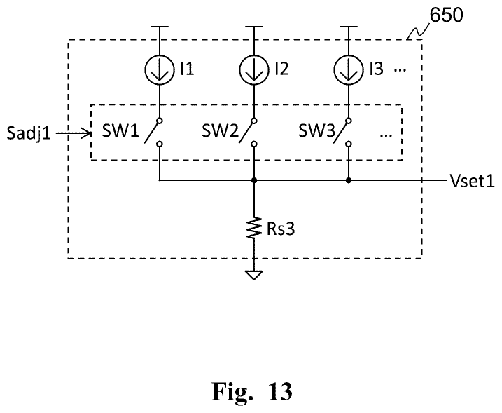

FIG. 13 shows a schematic diagram of a specific embodiment of the voltage generation circuit of the linear regulator according to the present invention. In one embodiment, the voltage generation circuit is configured as the DAC 650. The DAC 650 in FIG. 13 is a specific embodiment of the DAC 601 in FIG. 7 or one of the DACs in FIG. 8. In one embodiment, the DAC 650 includes a plurality of current sources (e.g. current sources I1˜13), corresponding number of a plurality of switches (e.g. switches SW1˜SW3) and a resistor Rs3. In this embodiment, the current sources I1-I3 are coupled in series to the switches SW1-SW3 respectively, and the switches SW1-SW3 are coupled in parallel to the resistor Rs3. The switches SW1-SW3 are controlled by the adjustment signal Sadj1, such that the switches SW1˜SW3 and the resistor Rs3 are configured to generate the first control voltage Vset1. In one embodiment, the levels of the current sources can be arranged in a binary-weighted manner.

The present invention has been described in considerable detail with reference to certain preferred embodiments thereof. It should be understood that the description is for illustrative purpose, not for limiting the scope of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. Furthermore, those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. The spirit of the present invention should cover all such and other modifications and variations, which should be interpreted to fall within the scope of the following claims and their equivalents.

What is claimed is:

1. A linear regulator, comprising:
a first output stage circuit, configured to operably generate a first output voltage according to a first control voltage; and
a calibration circuit, enabled during a first calibration period after the startup of the linear regulator, wherein during the first calibration period, the calibration circuit is configured to operably generate the first control voltage based on an output-related signal and a reference voltage, and the output-related signal is related to the first output voltage;
wherein the first output stage circuit and the calibration circuit form a first control loop, wherein the first control loop enters an open-loop state after the end of the first calibration period;
wherein the first output stage circuit includes a second control loop, configured to operably regulate the first output voltage in a closed-loop manner based on the first control voltage and a variation of the first output voltage during an operational period following the first calibration period.

2. The linear regulator of claim 1, wherein the calibration circuit is further configured to operably store the first control voltage after the end of the first calibration period; wherein after the calibration circuit stores the first control voltage, a portion of the calibration circuit is disabled, thereby entering the open-loop state.

3. The linear regulator of claim 2, wherein the calibration circuit includes:
a comparator, configured to generate a comparison signal based on a comparison between the output-related signal and the reference voltage during the first calibration period; and
a control circuit, configured to operably generate the first control voltage based on the comparison signal during the first calibration period;
wherein the comparator is disabled after the calibration circuit stores the first control voltage.

4. The linear regulator of claim 3, further comprising:
a sensing circuit, configured to operably generate the output-related signal based on the first output voltage during the first calibration period;
wherein the sensing circuit is disabled after the calibration circuit stores the first control voltage.

5. The linear regulator of claim 3, wherein the control circuit includes:
an adjustment circuit, configured to operably generate an adjustment signal based on the comparison signal during the first calibration period, and configured to operably store the adjustment signal after the end of the first calibration period; and
a voltage generation circuit, configured to generate the first control voltage based on the adjustment signal.

6. The linear regulator of claim 2, wherein the calibration circuit calibrates and generates the first control voltage according to a linear search method or a binary search method, such that a difference between a level of the output-related signal and a level of the reference voltage is less than a first threshold, thereby rendering a difference between a level of the first output voltage and a level of a target voltage less than a second threshold.

7. The linear regulator of claim 2, wherein the first output stage circuit includes:
a control terminal, configured to receive the first control voltage;
a regulated output terminal, configured to generate the first output voltage;
a bias current source, configured to operably generate a primary bias current at a bias node, wherein the primary bias current includes a first bias current and a second bias current; and
a first current branch and a second current branch, wherein the first current branch and the second current branch are coupled to the bias node, wherein the first bias current and the second bias current flow through the first current branch and the second current branch respectively;
wherein the first current branch is configured to operably generate a driving voltage according to the first bias current;
wherein the second current branch is configured to operably steer the second bias current, so as to steer the first bias current according to a voltage difference between the first output voltage and the first control voltage, and is configured to regulate the first output voltage according to the driving voltage and the second bias current.

8. The linear regulator of claim 7,
wherein the first current branch includes:
a bias load transistor and a common gate transistor, which are coupled in series between an input power and the bias node, and are configured to operably generate the driving voltage at a driving node according to the first bias current, wherein gates of the bias load transistor and the common gate transistor are biased by a first bias voltage and a second bias voltage, respectively;
wherein the second current branch includes:
a power transistor and a current steering transistor, which are coupled in series between the input power and the bias node, and are coupled at the regulated output terminal, wherein the driving voltage and the first control voltage are configured to control gates of the power transistor and the current steering transistor to generate the first output voltage.

9. The linear regulator of claim 7, wherein the first output stage circuit includes an overshoot suppressor circuit, wherein the overshoot suppressor circuit includes:
a first overshoot suppressing transistor and a suppressing resistor, which are coupled in series to the regulated output terminal and configured as a source follower, wherein a gate and a drain of the first overshoot suppressing transistor are coupled to the bias node and the regulated output terminal, respectively; and
a second overshoot suppressing transistor, coupled between the regulated output terminal and a ground, wherein a gate of the second overshoot suppressing transistor is coupled to an output of the source follower;
wherein the first overshoot suppressing transistor and the second overshoot suppressing transistor are configured to turn on when an overshoot of the first output voltage occurs, thereby suppressing the overshoot.

10. The linear regulator of claim 1, further comprising:
a plurality of output stage circuits, including at least the first output stage circuit and a second output stage circuit;
wherein the second output stage circuit is configured to operably generate a second output voltage according to a second control voltage;
wherein the calibration circuit is further configured to be enabled during a second calibration period following the first calibration period, wherein during the second calibration period, the calibration circuit is configured to operably generate the second control voltage based on the output-related signal and the reference voltage, and the output-related signal is related to the second output voltage;
wherein the second output stage circuit and the calibration circuit form a third control loop, wherein the third control loop enters the open-loop state after the end of the second calibration period;
wherein the second output stage circuit includes a fourth control loop, configured to operably regulate the second output voltage in the closed-loop manner based on the second control voltage and a variation of the second output voltage during the operational period following the second calibration period.

11. The linear regulator of claim 10, wherein the calibration circuit is further configured to operably store the second control voltage after the end of the second calibration period; wherein after the calibration circuit stores the second control voltage, a portion of the calibration circuit is disabled, thereby entering the open-loop state.

12. The linear regulator of claim 11, wherein the calibration circuit includes:
a comparator, configured to operably generate a comparison signal based on a comparison between the output-related signal and the reference voltage during the first calibration period or during the second calibration period; and
a control circuit, configured to operably generate the first control voltage based on the comparison signal during the first calibration period, or configured to operably generate the second control voltage based on the comparison signal during the second calibration period;
wherein the comparator is disabled after the calibration circuit stores the second control voltage.

13. The linear regulator of claim 12, further comprising:
a sensing circuit, configured to operably generate the output-related signal based on the first output voltage during the first calibration period, and configured to operably generate the output-related signal based on the second output voltage during the second calibration period;
wherein the sensing circuit is disabled after the calibration circuit stores the second control voltage.

14. The linear regulator of claim 10, wherein each of the first output stage circuit and the second output stage circuit includes:
a control terminal and a regulated output terminal;
a bias current source, configured to operably generate a primary bias current at a bias node, wherein the primary bias current includes a first bias current and a second bias current; and
a first current branch and a second current branch, wherein the first current branch and the second current branch are coupled to the bias node, wherein the first bias current and the second bias current flow through the first current branch and the second current branch respectively;
wherein the first current branch is configured to operably generate a driving voltage according to the first bias current;
wherein the second current branch is configured to operably steer the second bias current, so as to steer the first bias current according to a voltage difference between a regulated output voltage at the regulated output terminal and a control voltage received through the control terminal, and is configured to regulate the regulated output voltage according to the driving voltage and the second bias current;
wherein the control voltage of the first output stage circuit and the control voltage of the second output stage circuit correspond to the first control voltage and the second control voltage respectively, and the regulated output voltage of the first output stage circuit and the regulated output voltage of the second output stage circuit correspond to the first output voltage and the second output voltage respectively.
